(19) United States
(12) Patent Application Publication
(10) Pub. No.: US 2014/0341671 A1
(43) Pub. Date: Nov. 20, 2014

(54) MACHINE TOOL HAVING PROTECTIVE COVER

(71) Applicant: FANUC Corporation, Yamanashi (JP)

(72) Inventor: Naoki SATO, Yamanashi (JP)

(73) Assignee: FANUC Corporation, Yamanashi (JP)

(21) Appl. No.: 14/260,321

(22) Filed: Apr. 24, 2014

(30) Foreign Application Priority Data
May 15, 2013 (JP) 2013-103122

(51) Int. Cl. B23Q 11/08

(52) U.S. Cl. CPC B23Q 11/085
USPC 409/134

(57) ABSTRACT

A machine tool includes a bed, a column and linear-motion guides disposed over the bed, a saddle supported by the linear-motion guides, and a protective cover disposed between the column and the saddle. The saddle is guided by the linear-motion guides to move toward and away from the column. The protective cover includes upper surface portions, side surface portions extending parallel to the direction of movement of the saddle, and folded portions folded from lower ends of the side surface portions toward the linear-motion guides. The heights of the ends of the folded portions are lower than the heights of linear-motion guide mounting surfaces.

### BACKGROUND OF THE INVENTION

1. Field of the Invention

The present invention relates to a protective cover structure which is used in a machine tool and suitable for preventing the machine operation from causing cutting chips to enter the inside of the machine due to the use of the machine.

2. Description of the Related Art

Generally, in a machining center, which is a kind of machine tool, driving parts and surroundings are covered with a protective cover so that chips produced during machining may be prevented from accumulating on the driving parts and the surroundings, as disclosed in Japanese Patent No. JP2007-61952A.

With regard to a cover for protecting from chips a feed screw and linear-motion guides which drive a saddle in a front-back direction of a machine, the protective cover attached to the saddle moves back and forth in synchronization with the movement of the saddle, and prevents chips from accumulating on the feed screw and the linear-motion guides while entering and exiting a space under a column. Moreover, as shown in FIG. 5 of Japanese Patent No. JP2007-61952A, a wiper member for sweeping away chips accumulating on the protective cover is attached to the column. The wiper member removes chips accumulating on the surface of the protective cover in synchronization with the back-and-forth movement of the protective cover.

The protective cover generally has a shape in which portions near the linear-motion guides are bent toward the linear-motion guides so that chips may be prevented from entering the inside of the protective cover from below. In the case where the vertical positions of the bent portions are located above linear-motion guide mounting surfaces, it is inevitable that chips will accumulate on the linear-motion guide mounting surfaces or chamfered portions formed at edges of the linear-motion guide mounting surfaces. In the case where the protective cover moves in such a state, chips pushed by an end portion of the protective cover move on the linear-motion guide mounting surfaces or the chamfered portions located at the edges of the linear-motion guide mounting surfaces, with no member preventing the movement of the chips. As a result, the phenomenon that chips fall in the space under the column occurs.

### SUMMARY OF THE INVENTION

In view of the above-described problem of the prior art technique, an object of the present invention is to provide a machine tool including a protective cover which has a structure for preventing chips from accumulating on linear-motion guide mounting surfaces.

A machine tool according to the present invention includes a bed; a column disposed over the bed; a guide disposed over the bed; a saddle supported by the guide; and a protective cover disposed between the column and the saddle. The saddle is guided by the guide to move toward and away from the column. The protective cover includes an upper surface portion; a side surface portion extending parallel to a direction of movement of the saddle; and at least one folded portion folded from a lower end of the side surface portion toward the guide. A height of an end of the folded portion is lower than a height of a surface to which the guide is attached.

In the above-described machine tool, the folded portion may be inclined downward.

With the above-described configuration, the present invention can provide a machine tool including a protective cover which has a structure for preventing chips from accumulating on linear-motion guide mounting surfaces.

### BRIEF DESCRIPTION OF THE DRAWINGS

These and other objects and features of the present invention will become apparent from the following description of exemplary embodiments with reference to the accompanying drawings in which:

FIG. 1 is a schematic diagram showing a front view of a machine;

FIG. 2 is an enlarged view illustrating part C of FIG. 1;

FIG. 3 is a left side view of the machine shown in FIG. 1;

FIG. 4 shows a protective cover in a cross section taken along line A-A shown in FIG. 3 as seen in the direction indicated by arrows;

FIGS. 5A and 5B are enlarged views illustrating part D of FIG. 4;

FIGS. 6A, 6B, 6C, and 6D are views for explaining positional relationships between a linear-motion guide mounting surface and the end of a folded portion of the protective cover; and

FIGS. 7A, 7B, and 7C are views for explaining examples of the protective cover which have different edge shapes.

### DETAILED DESCRIPTION OF THE PREFERRED EMBODIMENTS

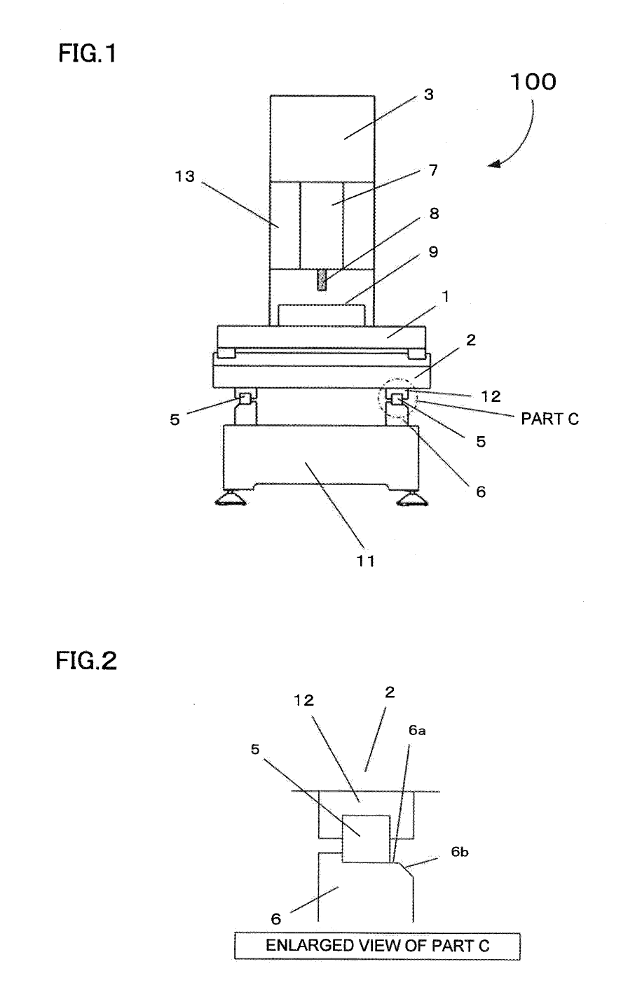

First, as shown in FIG. 1, a machine tool 100 includes a bed 11, a columnar-shaped column 3 installed upright over a rear portion of the bed 11.

The column 3 has a main shaft head 13 in an upper portion thereof on the front side. A main shaft 7 is attached to a front portion of the main shaft head 13. A tool 8 is installed in the main shaft 7.

A pair of linear-motion guide mount portions 6 and 6 are formed in front of the column 3 on the bed 11 to extend in the direction from a workpiece 9 toward the column 3. As shown in FIG. 2, upper surfaces of the linear-motion guide mount portions 6 and 6 are formed as linear-motion guide mounting surfaces 6a and 6a to which linear-motion guides 5 and 5 are fixed. By upper portions of the linear-motion guides 5 and 5, linear-motion guide receiving portions 12 and 12 fixed to a bottom portion of a saddle 2 are slidably supported. This configuration makes the saddle 2 movable in the direction toward the back of the drawing of FIG. 1. A table 1 is disposed on the saddle 2. The table 1 can be moved in the left-right direction of the drawing of FIG. 1 by a moving mechanism. The workpiece 9 is mounted on the table 1.

The saddle 2 and the table 1 are respectively driven by unillustrated drive motors controlled by an unillustrated controller of the machine tool 100. The workpiece 9 mounted on the table 1 is moved with respect to the tool 8 installed in the main shaft 7 along two mutually perpendicular axes to perform predetermined machining.

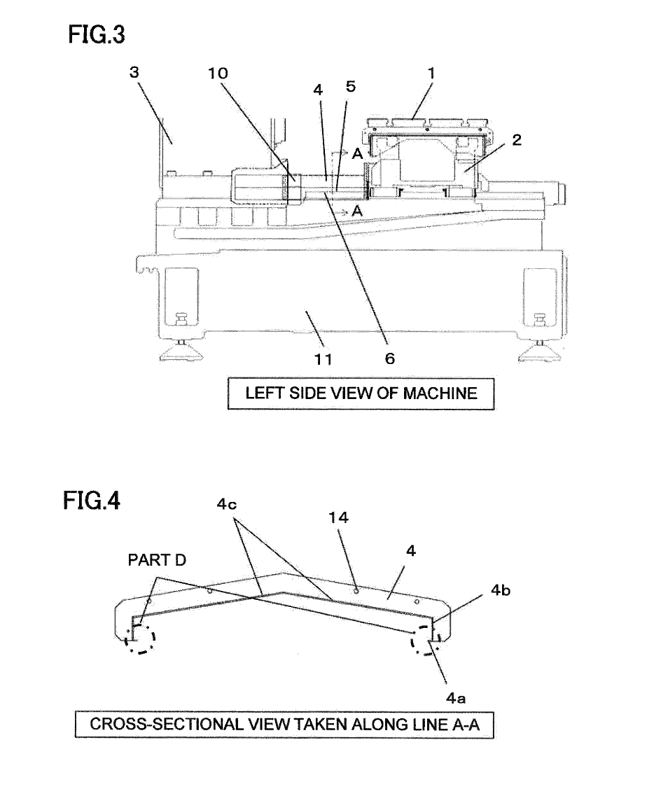

FIG. 3 is a left side view of the machine shown in FIG. 1. A protective cover 4 is fixed to the saddle 2 with unillustrated bolts to extend in the direction in which the pair of linear-motion guides 5 and 5 extend. The protective cover 4 is provided to prevent unillustrated cuttings produced by machining the workpiece from entering mechanical portions for driving the saddle 2, which include an unillustrated ball screw, the linear-motion guides 5 and 5, and the like.

As shown in FIG. 3, a recessed portion is provided in a surface of the column 3 on the saddle 2 side. When the saddle 2 moves to the left of the drawing of FIG. 3, a left end portion of the protective cover 4 fits into the recessed portion provided in the column 3. A wiper 10 for sweeping away cuttings accumulating on an upper portion of the protective cover 4 is attached around an entrance of the recessed portion provided in the column 3. The wiper 10 prevents cuttings from entering the recessed portion provided in the column 3 during the movement of the protective cover 4.

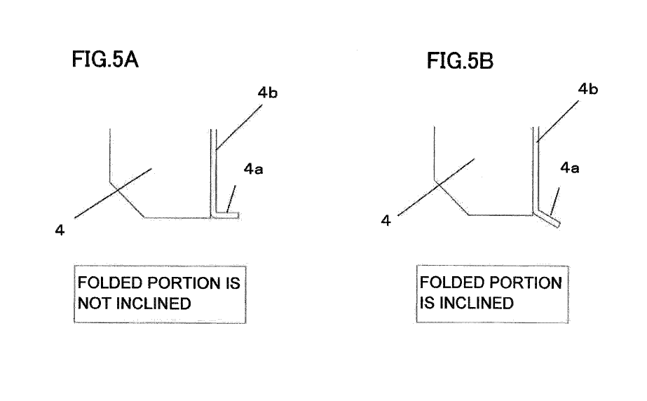

FIG. 4 shows a protective cover in a cross section taken along line A-A shown in FIG. 3 as seen in the direction indicated by arrows. As shown in FIG. 4, the protective cover 4 has upper surface portions 4c sloping down from a central portion toward side portions, side surface portions 4b vertically extending from side portions of the upper surface portions 4c, and folded portion 4a folded inward from lower ends of the side surface portions 4b. FIGS. 5A and 5B are enlarged views showing the left-side part D of FIG. 4. FIG. 5A shows a form in which the folded portion 4a is not inclined, and FIG. 5B shows a form in which the folded portion 4a is inclined.

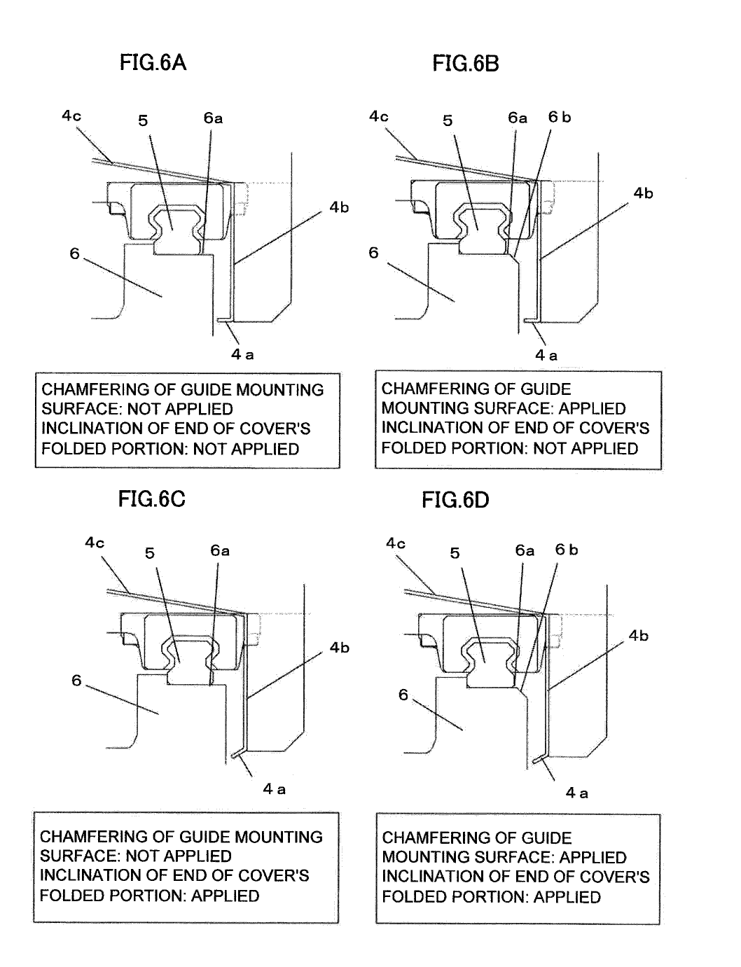

FIGS. 6A, 6B, 6C, and 6D show positional relationships between the linear-motion guide mounting surface and the end of the folded portion of the protective cover. In the protective cover 4 shown in FIG. 6A, the linear-motion guide mounting surface is not chamfered, and the end of the folded portion of the protective cover is not inclined. In the protective cover shown in FIG. 6B, the linear-motion guide mounting surface is chamfered, and the end of the folded portion of the protective cover is not inclined. In the protective cover 4 shown in FIG. 6C, the linear-motion guide mounting surface is not chamfered, and the end of the folded portion of the protective cover is inclined. In the protective cover shown in FIG. 6D, the protection guide mounting surface is chamfered, and the end of the folded portion of the protective cover is inclined.

As shown in FIGS. 6A, 6B, 6C, and 6D, the vertical position of the folded portion 4a, which is folded from the lower end of the protective cover 4 toward the linear-motion guide 5, is adjusted to be below the linear-motion guide mounting surface 6a. This prevents chips from accumulating on the linear-motion guide mounting surface 6a. In the case where the linear-motion guide mounting surface has a chamfered portion 6b at an edge thereof, the vertical position of the folded portion 4a of the protective cover 4 may adjusted to be below the chamfered portion 6b.

The shapes and fixed positions of the protective cover 4 and the protective cover's folded portion 4a are adjusted so that the vertical position of the protective cover's folded portion 4a may be below the linear-motion guide mounting surface 6a. In the case where the folded portion 4a is inclined, adjustment is also performed similarly.

In the case where the linear-motion guide mounting surface 6a has a chamfered portion 6b at an edge thereof, the vertical position of the protective cover's folded portion 4a is adjusted to be below the chamfered portion 6b.

It should be noted that a predetermined clearance is ensured between the end of the protective cover's folded portion 4a and the bed 11, to which the linear-motion guide 5 is attached, so that the end of the protective cover's folded portion 4a may not interfere with the bed 11 during the movement of the protective cover 4.

It should be noted that the folded portion may be inclined downward from the lower end of the protective cover 4 toward the linear-motion guide with the vertical position of the inclined portion being below the linear-motion guide mounting surface 6a so that chips can be prevented from accumulating on the linear-motion guide mounting surface 6a. Further, a predetermined clearance is ensured between the end of the folded portion 4a and the bed 11, to which the linear-motion guide 5 is attached, so that the end of the folded portion 4a may not interfere with the bed 11 during the movement of the protective cover 4.

The above-described configuration makes it possible to prevent chips from accumulating on the linear-motion guide mounting surfaces within the protective cover and the chamfered portions located at the edges of the linear-motion guide mounting surfaces.

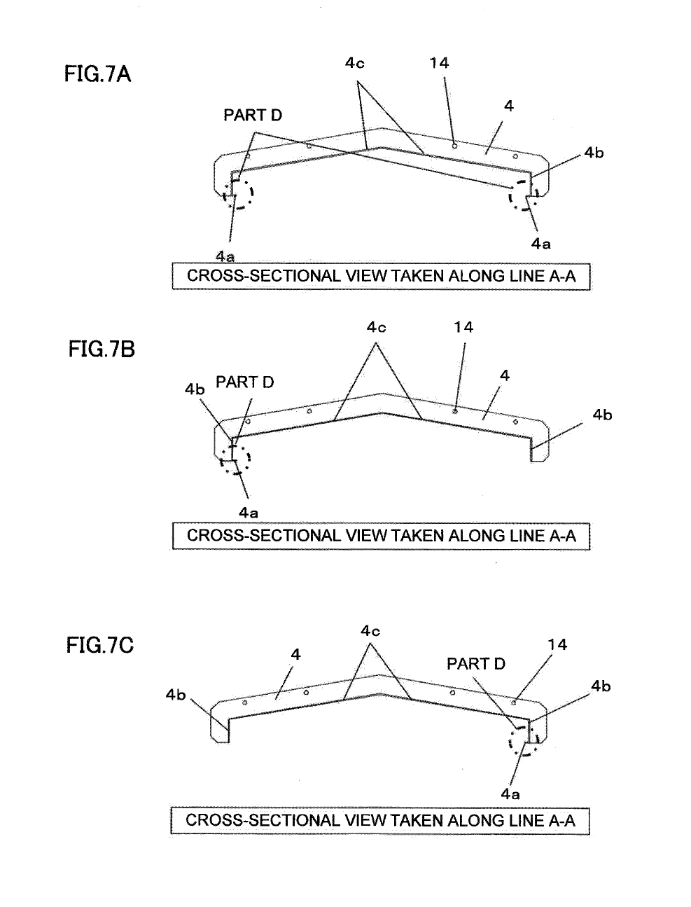

FIGS. 7A, 7B, and 7C show examples of the protective cover which have different edge shapes. FIG. 7A shows a form of the protective cover in which folded portions are provided in both side surface portions. FIG. 7B shows a form of the protective cover in which a folded portion is provided in a side surface portion on the left side of the drawing. FIG. 7C shows a form of the protective cover in which a folded portion is provided in a side surface portion on the right side of the drawing.

1. A machine tool comprising:
a bed;
a column disposed over the bed;
a guide disposed over the bed;
a saddle supported by the guide; and
a protective cover disposed between the column and the saddle; wherein
the saddle is guided by the guide to move toward and away from the column,
the protective cover includes
an upper surface portion,
a side surface portion extending parallel to a direction of movement of the saddle, and
at least one folded portion folded from a lower end of the side surface portion toward the guide, and
a height of an end of the folded portion is lower than a height of a surface to which the guide is attached.

2. The machine tool according to claim 1, wherein the folded portion of the protective cover is inclined downward.
